(19) United States
(12) Patent Application Publication
(10) Pub. No.: US 2008/0216760 A1
(43) Pub. Date: Sep. 11, 2008

(54) PET CARRIER

(75) Inventors: Rachel E. Cannon, Miami, OK (US); Tibor Siklosi, Joplin, MO (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(73) Assignee: BERGAN LLC, Miami, OK (US)

(21) Appl. No.: 11/739,687

(22) Filed: Apr. 24, 2007

Related U.S. Application Data
(63) Continuation-in-part of application No. 29/277,830, filed on Mar. 9, 2007.

(51) Int. Cl. A01K 1/00

(52) U.S. Cl. 119/497

(57) ABSTRACT

A pet carrier includes a hand access opening that communicates with the interior of the carrier and allows a pet owner to put a hand through the hand access opening to contact the pet without opening a pet opening on the pet carrier. The hand access opening is sized substantially smaller than the pet opening, thereby allowing the pet owner to put a hand through the hand access opening without fear of the animal in the carrier escaping through the hand access opening. The hand access opening allows a pet owner to pet and comfort the pet enclosed in the pet carrier without removing the pet from the pet carrier and without fear of the pet escaping.

### CROSS-REFERENCE TO RELATED APPLICATION

This patent application is a continuation-in-part of our earlier patent application entitled “Pet Carrier”, Ser. No. 29/277,830 filed on Mar. 9, 2007, which is incorporated herein by reference.

### BACKGROUND

1. Technical Field

This disclosure generally relates to accessories for pets, and more specifically relates to pet carriers.

2. Background Art

Pet carriers of various different sizes and configurations have been developed for transporting a pet, such as a dog or cat. Rigid pet carriers made of plastic and metal are well-known, and are often used when transporting a pet in a car, bus or airplane. These rigid pet carriers typically have a single entrance for the pet that comprises a metal gate that opens on one end of the pet carrier. The gate is opened, the pet is placed inside the carrier, and the gate is then closed to retain the pet within the carrier.

Recent advances have recognized that rigid pet carriers are bulky and difficult to carry. As a result, flexible pet carriers have been developed that are made of fabric and mesh material. The result is a carrier that looks much like a handbag or duffle bag, and is easily transported. Some flexible pet carriers include two separate pet entrances. For example, a side entrance and a top entrance may both be provided. Two entrances provides the pet owner more flexibility in using the carrier. For example, if the carrier is on a table, the pet owner might open the side pet entrance. If the carrier is on a floor, such as at the owner's feet on an airplane, the pet owner might open the top pet entrance to retrieve the pet from the carrier.

Some pets do not travel well, and need reassurance from their owners as they travel. Some pet owners also feel a need to comfort and reassure their pets. Known pet carriers, including rigid and flexible pet carriers, require the pet owner to open a pet entrance to touch and caress their pet. If a pet owner opens a pet entrance to put a hand into the carrier to rub and caress the pet, there is a possibility that the pet might escape from the carrier. While this may not be a big problem in some circumstances, it can be a serious problem if a pet escapes from the carrier on a crowded bus or airplane. A scared cat or dog could cause fear or injury to other passengers. Without a way to comfort a pet in a carrier without the possibility of the pet escaping, pet owners will either have to forego the comfort they would like to give to their pet, or risk having the pet escape from the carrier when the pet owner opens the pet entrance to comfort the pet.

### BRIEF SUMMARY

A pet carrier includes a hand access opening that communicates with the interior of the carrier and allows a pet owner to put a hand through the hand access opening to contact the pet without opening a pet opening on the pet carrier. The hand access opening is sized substantially smaller than the pet opening, thereby allowing the pet owner to put a hand through the hand access opening without fear of the animal in the carrier escaping through the hand access opening. The hand access opening allows a pet owner to pet and comfort the pet enclosed in the pet carrier without removing the pet from the pet carrier, without fear of the pet escaping and without fear of the carrier distorting in shape from opening a pet opening.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a perspective view of a pet carrier that includes a hand access opening that allows a pet owner to touch the pet in the carrier without risk of the pet escaping from the carrier;

FIG. 2 is a front view of the pet carrier showing a person's hand passing through the hand access opening to touch a pet in the interior of the pet carrier;

FIG. 3 is a back view of the pet carrier;

FIG. 4 is a left side view of the pet carrier;

FIG. 5 is a right side view of the pet carrier; and

FIG. 6 is a top view of the pet carrier.

### DETAILED DESCRIPTION

A pet carrier includes a hand access opening that allows a person to place a hand through the hand access opening to touch the pet inside the carrier. The size of the hand access opening is sufficiently small that an animal of a specified size the pet carrier is designed to carry cannot escape out of the hand access opening. This allows a person to pet and caress the pet in the carrier without risk of the animal escaping, thereby providing a more enjoyable travel experience for both pet and person. In addition, the hand access opening allows immediate and unrestricted access to the pet while in transit/motion in the pet carrier.

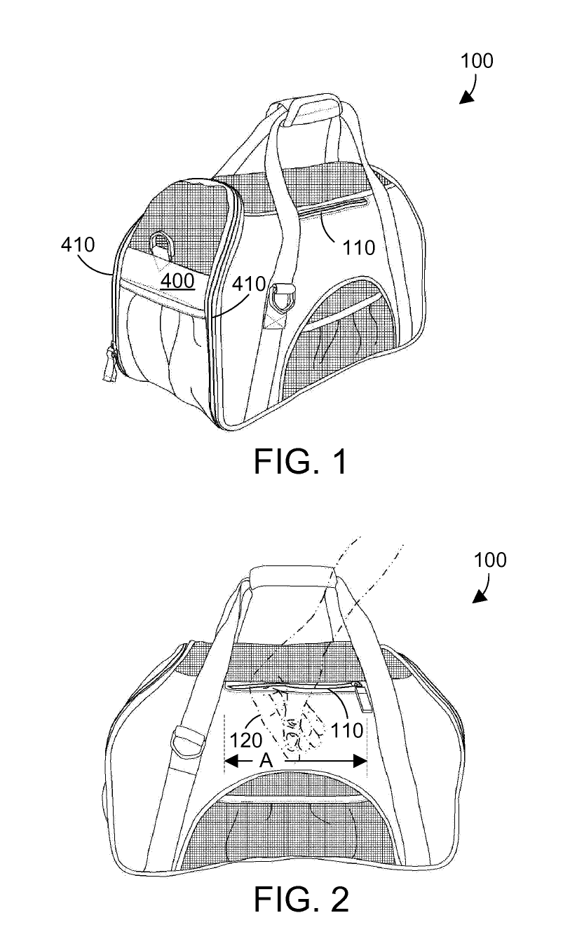

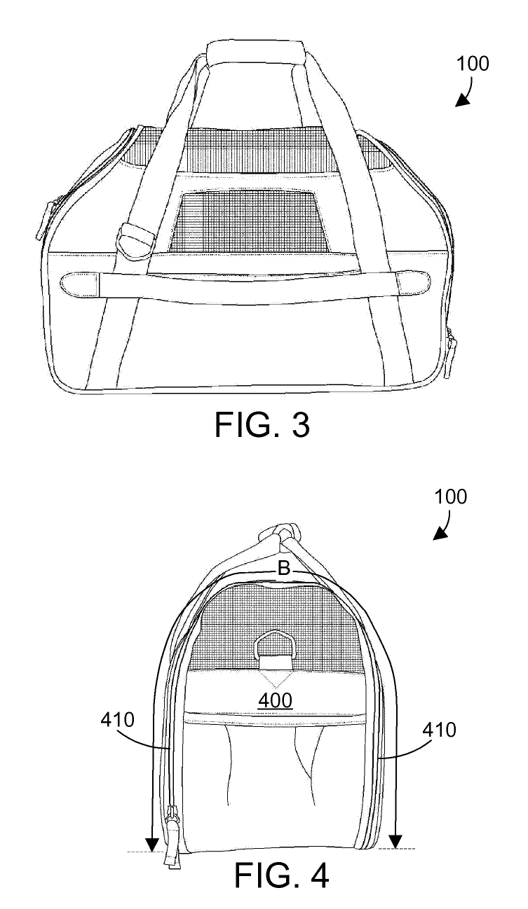

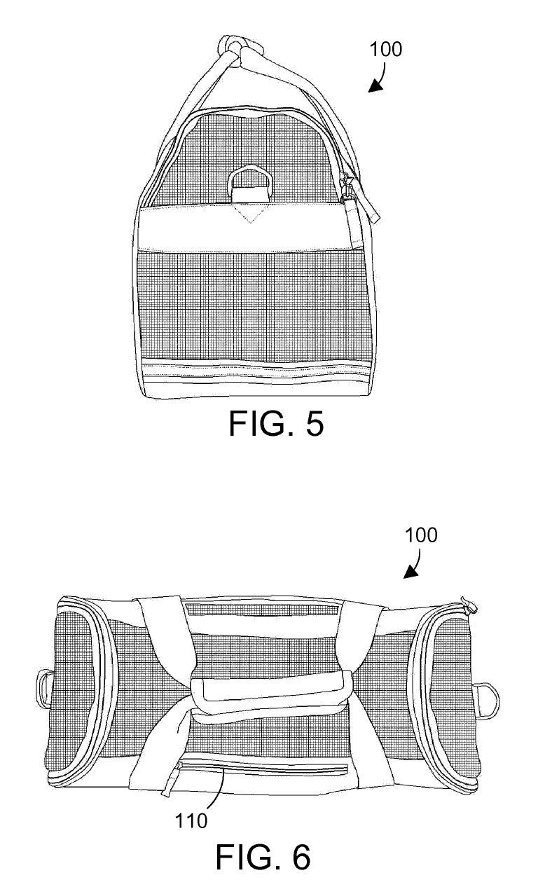

A pet carrier 100 is shown in various views in the figures. The pet carrier 100 includes a pet opening 400 on the left side panel as shown in FIGS. 1 and 4. The pet opening 400 is defined by a zipper 410 that wraps around the sides and top of the left side panel as shown in FIGS. 1 and 4. The pet opening 400 has a lineal dimension B in FIG. 4 that is equal to the length of the zipper 410 if laid in a straight line. Thus, the zipper 410 shown in FIG. 4 has a lineal dimension B that includes the length of both sides and the top of the side panel 400, as shown in FIG. 4.

A person using a prior art pet carrier with a side entrance 400 as shown in FIG. 4 might be tempted to contact the pet in the carrier by unzipping the zipper 410 only a small amount, then placing a hand through the unzipped part of zipper 410. While a user of a prior art pet carrier could contact and comfort the pet in this manner, there is a risk that the zipper 410 could open enough for the pet to escape from the pet carrier. Indeed, if the pet were to press the person's arm against the closed portion of the zipper, the zipper would unzip more, potentially unzipping enough to allow the pet to escape. Having an animal escape from a carrier is very undesirable. In addition, opening a pet opening while transporting a prior art carrier with a pet inside is a two-handed operation, which is inconvenient. Also, the pet carrier would become somewhat deformed in structure, potentially causing discomfort or injury to the pet.

The pet carrier disclosed and claimed herein eliminates the problems associated with contacting a pet inside a pet carrier via the pet opening. Instead of contacting a pet via the pet opening, a different opening referred to herein as a hand access opening is provided. The hand access opening preferably includes a closure mechanism, such as a zipper, and is sized to prevent the escape of the animal through the hand access opening. The closure mechanism makes the hand access opening 110 an open and closable opening in such a manner that does not alter the structural integrity of the pet carrier.

One suitable implementation of a hand access opening 110 is shown in FIGS. 1, 2 and 6, and preferably includes a closure mechanism such as a zipper. Of course, other closure mechanisms could be used, including without limitation buttons, snaps, hook-and-loop fasteners, an elastic drawstring, and metal bands that provide a bias that closes the opening until the bias is overcome by a person's hand to pop open the opening. Other closure mechanisms not listed are also within the scope of the disclosure and claims herein. The hand access opening 110 has a lineal dimension A in FIG. 2 that is large enough for a person's hand to pass, but not large enough for a pet of a specified size for which the pet carrier was designed to escape from the hand access opening 110. Many pet carriers have a specification such as a weight limit that determines what size of animal is specified for the pet carrier. For example, if a pet carrier has a maximum weight specification of 8 kilograms, the pet carrier is designed for a pet of a specified size, namely less than 8 kilograms. A person's hand is shown in phantom at 120 in FIG. 2 passing through the hand access opening 110 into the interior of the pet carrier 100 to touch a pet within the pet carrier 100.

In one suitable implementation, the lineal dimension A of the hand access opening in FIG. 2 is less than half of the lineal dimension B of the pet opening in FIG. 4. For example, the hand access opening could have a lineal dimension greater than 30 cm while the hand access opening has a lineal dimension less than 15 cm. In a preferred implementation, the lineal dimension A of the hand access opening is less than a third of the lineal dimension B of the pet opening. In the most preferred implementation, the lineal dimension A of the hand access opening is less than a fourth of the lineal dimension B of the pet opening. In addition, the lineal dimension of the hand access opening A is suitably at least 4 cm, preferably at least 5 cm, and most preferably at least 6 cm. By providing a hand access opening 110 with a lineal dimension A that is substantially less than the lineal dimension B of the pet opening, the hand access opening will allow a person's hand to pass through to contact the pet within the interior portion of the carrier without risk of the pet escaping. In the most preferred implementation, the hand access opening 110 is a substantially linear opening, as shown in FIGS. 1 and 2, thereby creating a slot through which a person may reach a hand to contact an animal in the interior of the carrier 100. The hand access opening 110 may include a flap of material inside the pet carrier that restricts access by the pet inside the pet carrier to the hand access opening. The hand access opening 110 makes it possible for a person carrying the pet carrier to contact the pet inside the pet carrier without opening a pet opening. Structural support of soft-side pet carriers is complete and structurally sound only when all pet openings are closed. Opening the pet opening alters and undermines the structure, causing collapse on the pet inside, causing discomfort and/or injury to the pet. The hand access opening 110, in contrast, allows a person to contact the pet inside the carrier without altering the structural integrity of the pet carrier.

The placement of the hand access opening 110 on the carrier 100 may be varied. The hand access opening 110 is preferred to be on the upper half of the carrier 100. However, the hand access opening 110 may be located in any suitable location on the carrier 100, and is most preferably in a location that does not alter the structural integrity of the pet carrier when the hand access opening 110 is open. The location of the hand access opening 110 affects the convenience of the person carrying the carrier. For example, with the handles as shown in the figures, a person could carry the pet carrier 100 on a shoulder. If the pet carrier 100 were placed on a person's left shoulder with the front panel placed next to the person's body, the person could easily unzip the hand access opening 110 and place the right hand inside the carrier to comfort the pet without removing the pet carrier 100 from the shoulder. In similar fashion, placing the hand access opening on the upper portion of the front panel allows a person to set the pet carrier in an adjacent seat, and the person may then unzip the hand access opening 110 to contact the pet within the pet carrier in a convenient manner.

Pet carrier 100 is preferably flexible, and may include any suitable flexible material. In the most preferred implementation, pet carrier 100 includes one or more mesh panels, as shown in the figures, which provide ventilation for the pet in the carrier.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

What is claimed is:

1. A flexible pet carrier comprising:
an interior portion for holding a pet of a specified size;
at least one open and closable pet opening that opens to the interior portion and is sized to allow placing the pet in the interior portion and removing the pet from the interior portion; and
an open and closable hand access opening that opens to the interior portion and is sized to allow a person's hand to pass through the hand access opening and contact the pet in the interior portion and is further sized to prevent the pet of the specified size from exiting the interior portion through the hand access opening.

2. The flexible pet carrier of claim 1 wherein the interior portion is defined by a plurality of flexible fabric panels and the hand access opening is within an upper portion of one of the flexible fabric panels.

3. The flexible pet carrier of claim 1 wherein the pet opening has a lineal dimension, wherein the hand access opening has a lineal dimension, and wherein the hand access opening has a lineal dimension less than half of the lineal dimension of the pet opening.

4. The flexible pet carrier of claim 1 wherein the pet opening has a lineal dimension, wherein the hand access opening has a lineal dimension, and wherein the hand access opening has a lineal dimension less than a third of the lineal dimension of the pet opening.

5. The flexible pet carrier of claim 1 wherein the pet opening has a lineal dimension, wherein the hand access opening has a lineal dimension, and wherein the hand access opening has a lineal dimension less than a fourth of the lineal dimension of the pet opening.

6. The flexible pet carrier of claim 1 wherein the pet opening has a lineal dimension greater than 30 cm and wherein the hand access opening has a lineal dimension of less than 15 cm.

7. The flexible pet carrier of claim 1 wherein the hand access opening comprises a substantially linear opening.

8. The flexible pet carrier of claim 1 wherein the hand access opening is separate from the at least one pet opening and allows the person's hand to pass through the hand access opening and contact the pet in the interior portion without risk of the pet carrier collapsing around the pet.

9. A flexible pet carrier comprising:
a bottom panel that is sufficiently rigid to substantially retain its shape when the pet carrier is transported with a pet resting on the bottom panel;
first and second side panels coupled to the bottom panel, at least one of the first and second side panels including a pet opening comprising a closure mechanism that opens to place a pet in an interior portion of the pet carrier;
a back panel coupled to the bottom panel and coupled to the first and second side panels; and
a front panel coupled to the bottom panel and coupled to the first and second side panels, the front panel comprising an open and closable hand access opening that communicates with an interior portion of the flexible pet carrier where the pet is placed, allowing a person carrying the flexible pet carrier to place a hand through the hand access opening and touch the pet without opening the pet opening.

10. The flexible pet carrier of claim 9 wherein at least one of the first and second side panels, the back panel, and the front panel comprises mesh.

11. The flexible pet carrier of claim 9 wherein the pet opening has a lineal dimension, wherein the hand access opening has a lineal dimension, and wherein the hand access opening has a lineal dimension less than half of the lineal dimension of the pet opening.

12. The flexible pet carrier of claim 9 wherein the pet opening has a lineal dimension, wherein the hand access opening has a lineal dimension, and wherein the hand access opening has a lineal dimension less than a third of the lineal dimension of the pet opening.

13. The flexible pet carrier of claim 9 wherein the pet opening has a lineal dimension, wherein the hand access opening has a lineal dimension, and wherein the hand access opening has a lineal dimension less than a fourth of the lineal dimension of the pet opening.

14. The flexible pet carrier of claim 9 wherein the pet opening has a lineal dimension greater than 30 cm and wherein the hand access opening has a lineal dimension of less than 15 cm.

15. The flexible pet carrier of claim 9 wherein the hand access opening comprises a substantially linear opening.

16. A flexible pet carrier comprising:
a bottom panel that is sufficiently rigid to substantially retain its shape when the pet carrier is transported with a pet resting on the bottom panel;
first and second side panels coupled to the bottom panel, at least one of the first and second side panels including a pet opening comprising at least one zipper of a first lineal length that opens to place a pet in an interior portion of the pet carrier;
a back panel coupled to the bottom panel and coupled to the first and second side panels; and
a front panel coupled to the bottom panel and coupled to the first and second side panels, the front panel comprising a hand access opening comprising a second zipper of a second lineal length that is less than half the first lineal length of the at least one zipper of the pet opening, the hand access opening communicating with an interior portion of the flexible pet carrier where the pet is placed, allowing a person carrying the flexible pet carrier to unzip the hand access opening and place a hand through the hand access opening and touch the pet without opening the pet opening.

17. The flexible pet carrier of claim 16 wherein the second lineal length is less than a third of the first lineal length.

18. The flexible pet carrier of claim 16 wherein the second lineal length is less than a fourth of the first lineal length.

19. The flexible pet carrier of claim 16 wherein the first lineal length is greater than 30 cm and wherein the second lineal length is less than 15 cm.

20. The flexible pet carrier of claim 16 wherein the hand access opening comprises a substantially linear opening.
